(19) United States
(12) Patent Application Publication
(10) Pub. No.: US 2026/0277181 A1
(43) Pub. Date: Sep. 17, 2026

(54) PROGRAM CREATION SUPPORT DEVICE AND COMPUTER PROGRAM PRODUCT

(71) Applicant: Keyence Corporation, Osaka (JP)

(72) Inventors: Shogo MATSUI, Osaka (JP); Keiya Shimomura, Osaka (JP)

(73) Assignee: Keyence Corporation, Osaka (JP)

(21) Appl. No.: 19/678,209

(22) Filed: May 15, 2026

Related U.S. Application Data
(63) Continuation of application No. PCT/JP2024/042872, filed on Dec. 4, 2024.

(30) Foreign Application Priority Data
Dec. 25, 2023 (JP) 2023-218360

(51) Int. Cl. G05B 19/05

(52) U.S. Cl. CPC G05B 19/056; G05B 19/054

(57) ABSTRACT

It is possible for a user who creates a control program used in a PLC to benefit from LLM. First information regarding an input and output device connected to a PLC, second information regarding at least one of a command or a program module for controlling the input and output device, and third information indicating a control content realized in combination with the command or the program module are received in natural language. Based on these pieces of information, a prompt in natural language for generating a text code corresponding to a ladder diagram (LD) is generated. The prompt is transmitted to an LLM, and a response statement is received from the LLM. A text code included in the response statement is converted into an LD. The prompt includes fourth information for constraining the text code included in the response statement to be suitable for the conversion into the LD.

### CROSS-REFERENCE TO RELATED APPLICATIONS

The present application is a continuation of International Application No. PCT/JP2024/042872, filed Dec. 4, 2024, and claims foreign priority based on Japanese Patent Application No. 2023-218360, filed Dec. 25, 2023, the contents of which are incorporated herein by references.

### BACKGROUND OF THE INVENTION

### 1. Technical Field

The present invention relates to a program creation support device and a computer program product.

### 2. Description of the Related Art

A programmable logic controller (PLC) calculates a control signal based on a control program (ladder program) created by a user using a ladder diagram (ladder language), a signal input from a sensor, and the like, and outputs the control signal to an actuator, motor, and the like to be connected. The ladder language is a programming language assumed to be used in the PLC, and is not used in a general-purpose computer. Thus, there is a problem that there are few programmers who are proficient in the ladder language.

When the programming by the ladder language can be assisted, the burden on a user who tries to create the ladder program can be reduced.

U.S. Pat. No. 7,324,856 B describes a device that automatically generates a control code for controlling an operation of each process by a user arranging a component of each process at a desired position on a graphical user interface (GUI) when a control program of a human machine interface (HMI) which is a display of a PLC is created.

Meanwhile, a large language model called a large language model (LLM) is becoming widespread. An LLM is a model that outputs plausible responses to natural language inputs by being machine-trained on a large volume of text data. Data used for machine learning is collected from the Internet or the like. Thus, the LLM is good at generating a program code written in a general-purpose programming language by performing machine learning on a source code written in the general-purpose programming language (example: Python, Java, C++, JavaScript, C#, and the like) that can be easily collected through the Internet.

When the ladder program used in the PLC can also be generated by using the LLM, a work load of the user can be reduced. However, since the ladder program is hardly disclosed on the Internet, the LLM could not sufficiently learn the ladder program. In particular, there was no LLM that outputs the ladder program by using natural language as an input. Thus, it was not possible for a user who tries to create the ladder program to benefit from the LLM.

### SUMMARY OF THE INVENTION

Therefore, an object of the present invention is to enable a user who creates a control program used in a programmable logic controller, such as a ladder program, to benefit from an LLM.

The present invention provides, for example, a program creation support device that supports creation of a control program used in a programmable logic controller, the program creation support device including:
an information reception unit that receives, in natural language, first information regarding an input and output device connected to the programmable logic controller, second information regarding at least one of a command or a program module for controlling the input and output device, and third information indicating a control content realized in combination with the command or the program module;
a prompt generation unit that generates a prompt in natural language for generating a text code corresponding to a ladder diagram based on the first information, the second information, and the third information received by the information reception unit;
an LLM interface that transmits the prompt generated by the prompt generation unit to a large language model (LLM) and receives a response statement corresponding to the prompt from the large language model; and
a conversion unit that converts a text code included in the response statement received via the LLM interface into a ladder diagram,
in which the prompt generation unit adds, to the prompt, fourth information for constraining the text code included in the response statement to be suitable for the conversion into the ladder diagram by the conversion unit.

According to the present invention, it becomes possible for the user who creates the control program used in the programmable logic controller, such as the ladder program, to benefit from the LLM.

### BRIEF DESCRIPTION OF THE DRAWINGS

FIG. 1 is a diagram for explaining a PLC system;

FIG. 2 is a diagram for explaining a setting support device (program creation support device);

FIG. 3 is a diagram for explaining a basic unit;

FIG. 4 is a diagram for explaining functions implemented in setting software;

FIG. 5 is a sequence diagram illustrating creation of a user program and a transfer procedure;

FIG. 6 is a flowchart illustrating a creation procedure of a ladder program;

FIG. 7 is a flowchart illustrating the creation procedure of the ladder program;

FIG. 8 is a flowchart illustrating an error correction procedure;

FIG. 9 is a sequence diagram illustrating creation of a user program and a transfer procedure;

FIG. 10 is a diagram for explaining a generated ladder diagram;

FIG. 11 is a diagram for explaining a generated function block; and

FIG. 12 is a diagram for explaining the generated ladder diagram.

### DETAILED DESCRIPTION

Hereinafter, embodiments will be described in detail with reference to the accompanying drawings. Note that the following embodiments do not limit the invention according to the claims, and all combinations of features described in the embodiments are not necessarily essential to the invention. Two or more features of a plurality of features described in the embodiments may be arbitrarily combined. In addition, the same or similar configurations are denoted by the same reference numerals, and redundant description will be omitted.

### <PLC System>

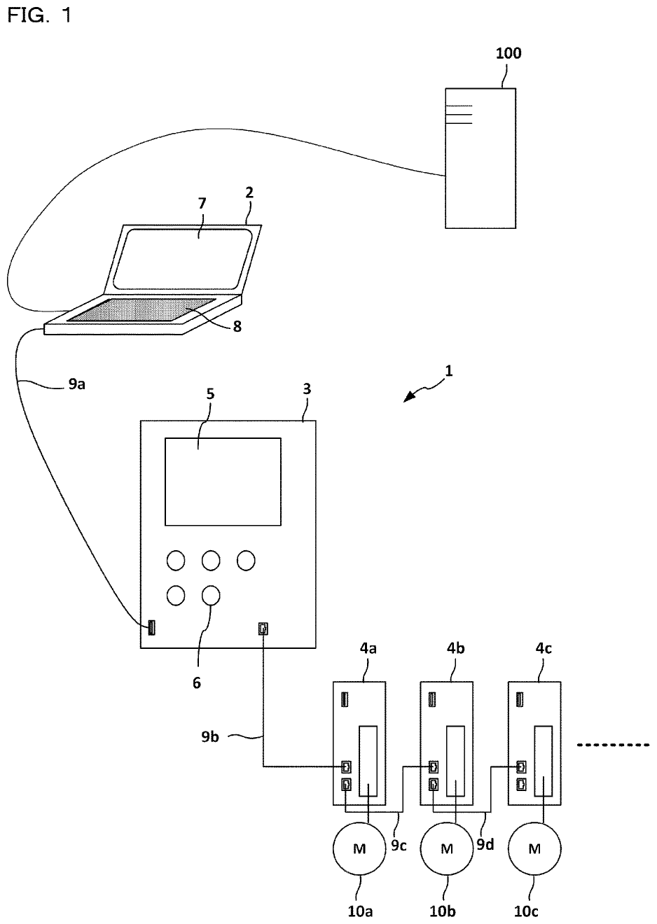

FIG. 1 illustrates a configuration example of a programmable logic controller system (hereinafter, referred to as a PLC system 1.) according to an embodiment of the present invention. As illustrated in FIG. 1, the PLC system 1 includes a PC that is a setting support device for editing a user program such as a ladder program, a basic unit 3 that is a programmable logic controller (PLC) for comprehensively controlling various control devices installed in a factory or the like, and a plurality of motor drivers 4a to 4c. The plurality of motor drivers 4a to 4c drives motors 10a, 10b, and 10c, respectively. The motor drivers 4a to 4c may be referred to as motor amplifiers or motion units. The motors 10a, 10b, and 10c drive loads as control targets.

A user program created by a PC 2, which is the setting support device, may be created by using a graphical programming language such as a ladder language, a flowchart-format motion program, or a structured text (ST) language, or may be created by using a high-level programming language such as C language.

In the PLC system 1, one or a plurality of extension units (example: I/O unit, analog input unit, analog output unit, communication unit, motor drivers 4a to 4c, and the like) are connected to the basic unit 3. The basic unit 3 may also be referred to as a CPU unit.

The basic unit 3 includes a display unit 5 and an operation unit 6. The display unit 5 can display operation statuses of the motor drivers 4a to 4c. The display unit 5 may switch a display content according to an operation content of the operation unit 6. The display unit 5 normally displays a current value (device value) of a device in the PLC system 1, error information (presence or absence of an alarm or warning) occurring in the PLC system 1, and the like. The device is a name indicating a region on a memory provided to store a device value (device data), and may be referred to as a data memory or a device memory. The device value is information indicating an input state from an input device, an output state to an output device, and states of an internal relay (auxiliary relay), a timer, a counter, a data memory, and the like set on the user program. Types of the device value include a bit type and a word type. A bit device stores a 1-bit device value. A word device stores a 1-word device value.

The motor drivers 4a to 4c are prepared to extend functions of the PLC system 1. The motors 10a to 10c are controlled by the motor drivers 4a to 4c, respectively. The motor drivers 4a to 4c supply power to the motors 10a to 10c, and control a rotation amount and the like according to a command from the basic unit 3. The motors 10a to 10c are, for example, servo motors, stepping motors, and the like.

The PC 2 is a computer that provides a development environment of the PLC system 1. The PC 2 is, for example, a portable notebook or tablet personal computer, and includes a display unit 7 and an operation unit 8. A ladder program, which is an example of the user program for controlling the PLC system 1, is created by using the PC 2. The created ladder program is converted into a mnemonic code in the PC 2. The PC 2 is connected to the basic unit 3 of the PLC system 1 via a communication cable 9a such as a universal serial bus (USB), and sends the ladder program converted into the mnemonic code to the basic unit 3. The basic unit 3 converts the ladder program into a machine code and stores the machine code in a memory included in the basic unit 3. Note that, although the mnemonic code is transmitted to the basic unit 3 here, the present invention is not limited thereto. For example, the PC 2 may convert the mnemonic code into an intermediate code, and transmit the intermediate code to the basic unit 3.

Note that, although not illustrated in FIG. 1, the operation unit 8 of the PC 2 may include a pointing device such as a mouse connected to the PC 2. In addition, the PC 2 may be configured to be detachably connected to the basic unit 3 via the communication cable 9a other than USB. In addition, the PC 2 may be wirelessly connected to the basic unit 3 without the communication cable 9a. In this case, the communication cable 9a may be understood to express a wireless link.

The basic unit 3 and the motor driver 4a are connected by a communication cable 9b, and can communicate with each other via the communication cable 9b. The motor driver 4a and the motor driver 4b are connected by a communication cable 9c, and can communicate with each other via the communication cable 9c. The motor driver 4b can communicate with the basic unit 3 via the communication cables 9b and 9c. The motor driver 4b and the motor driver 4c are connected by a communication cable 9d, and can communicate with each other via the communication cable 9d. In addition, the motor driver 4c can communicate with the basic unit 3 via the communication cables 9b, 9c, and 9d.

Hereinafter, the motor drivers 4a to 4c are referred to as the motor driver 4 in a case where common matters are described. Similarly, the motors 10a to 10c are referred to as the motor 10 in a case where common matters are described.

An LLM server 100 is, for example, a server computer or a service connected to the Internet. The PC 2 accesses the LLM server 100 via the Internet, transmits a prompt, and receives a response (response statement) to the prompt. The LLM server 100 has been machine-trained on a large number of source codes written in general-purpose programming languages represented by Python, Java, C++, JavaScript, C#, and the like. For example, when the PC 2 transmits, as a prompt, content to be realized by a desired program written in C language to the LLM server 100, the desired program written in C language for realizing the content designated by the prompt is received as the response statement. Note that the LLM server 100 may be implemented inside the PC 2.

### <Setting Support Device>

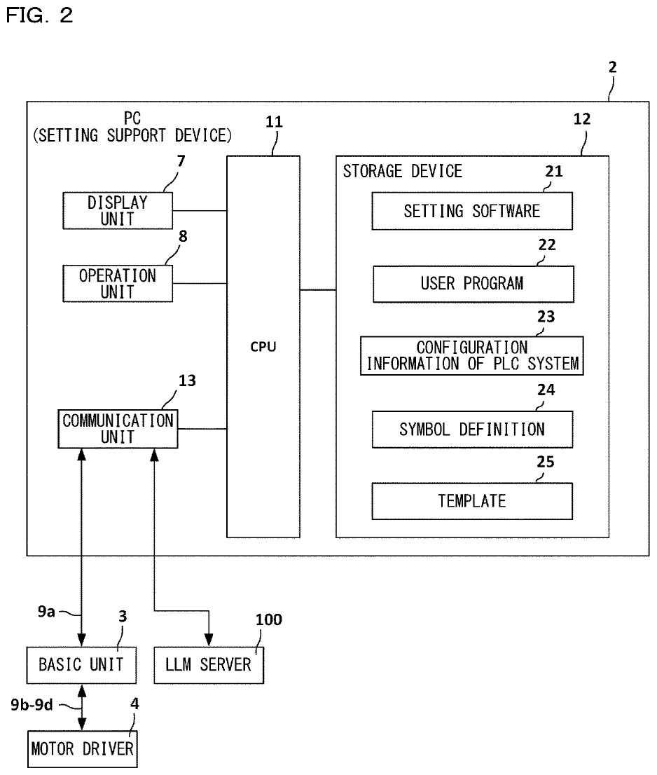

FIG. 2 is a block diagram for explaining an electrical configuration of the PC 2 operating as the setting support device. As illustrated in FIG. 2, the PC 2 includes a CPU 11, the display unit 7, the operation unit 8, a storage device 12, and a communication unit 13. The display unit 7, the operation unit 8, the storage device 12, and the communication unit 13 are electrically connected to the CPU 11. The storage device 12 includes a RAM, a ROM, an HDD, and an SSD, and may further include a detachable memory card. The CPU is an abbreviation for central processing unit. The ROM is an abbreviation for read-only memory. The RAM is an abbreviation for random-access memory. The HDD is an abbreviation for a hard disk drive. The SSD is an abbreviation for a solid state drive.

A user of the PC 2 causes the CPU 11 to execute setting software 21 stored in the storage device 12, edits a user program 22 through the operation unit 8, and transmits the user program 22 to the basic unit 3. In addition, the setting software 21 has a module that transmits a prompt to the LLM server 100, receives the response statement from the LLM server 100, and assists creation of the user program 22. The details thereof will be described later. The PC 2 may be referred to as an engineering tool. The user program 22 is a ladder program, a motion program, or the like.

Configuration information 23 of the PLC system is information indicating connection positions of the plurality of motor drivers 4 with respect to the basic unit 3 and functions (example: communication function and positioning function) provided in the basic unit 3, information indicating a function and the like of the motor driver 4, and device assignment information. The user program 22 and the configuration information 23 of the PLC system are a part of project data. Here, the editing of the project data includes creation and change (re-editing) of the project data. The user reads the project data stored in the storage device 12 as necessary, and changes the project data by using the setting software 21.

Symbol definition 24 is a definition of various symbols (example: variables and devices) used in the PLC system 1. A template 25 is existing textual information used in creating a prompt to be sent to the LLM server 100.

The communication unit 13 communicates with the basic unit 3 via the communication cable 9a. The CPU 11 transfers the project data (such as the user program 22 and the configuration information 23) to the basic unit 3 via the communication unit 13. The communication unit 13 includes a communication circuit capable of executing communication conforming to the USB standard, a communication circuit that performs wired LAN communication, a communication circuit that performs wireless LAN communication, and the like.

The communication unit 13 communicates with the LLM server 100 via a communication cable and the Internet. A communication protocol between the PC 2 and the basic unit 3 may be a general-purpose protocol or a proprietary protocol.

### <Basic Unit>

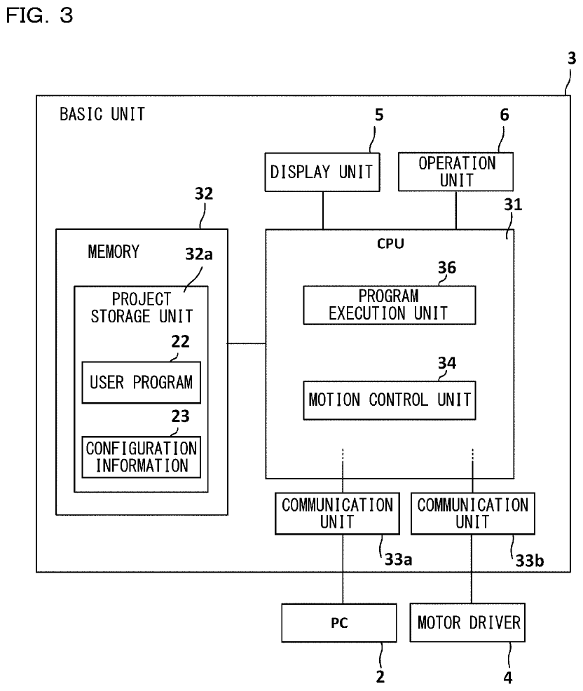

FIG. 3 illustrates a hardware configuration of the basic unit 3. A CPU 31 writes information in a memory 32 and reads information from the memory 32. The memory 32 includes a RAM, a ROM, an HDD, and an SSD, and may further include a detachable memory card. A project storage unit 35 is a ROM region that stores the project data created and transferred by the PC 2. The project data includes the user program 22, the configuration information 23, and the like. Further, the CPU 31 receives an input of information from the operation unit 6. The CPU 31 displays various kinds of information on the display unit 5.

The CPU 31 is connected to the PC 2 via a communication unit 33a, and is connected to the motor driver 4 via a communication unit 33b to perform communication. The communication unit 33a is, for example, a communication circuit compatible with USB. The communication unit 33b is a communication circuit capable of executing communication compatible with the Industrial Ethernet Protocol (example: EtherCAT, EtherNet/IP, PROFINET, and MECHATROLINK-III).

A program execution unit 36 is an arithmetic processing circuit that executes the user program 22. The program execution unit 36 may be implemented on another CPU different from the CPU 31. The motion control unit 34 controls the motor driver 4 in cooperation with the program execution unit 36.

### <Editing of User Program>

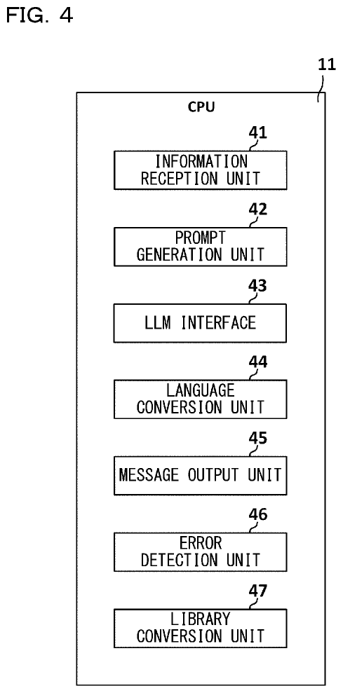

FIG. 4 illustrates some of various functions realized by the CPU 11 executing the setting software 21. An information reception unit 41 displays a user interface of the setting software 21 on the display unit 7 for the user. Further, the information reception unit 41 receives various kinds of information, instructions, and the like input by the user through the operation unit 8. For example, such information is input in natural language that can be understood by humans. The information to be input may include, for example, first information regarding an input and output device (example: motor driver 4) connected to the basic unit 3, second information regarding at least one of a command or a program module for controlling the input and output device, and third information indicating a control content realized in combination with the command or the program module.

The first information may include role information indicating a role of each of a plurality of input devices connected to the basic unit 3. The role information included in the first information may be reflected in a variable name or a comment in a ladder diagram.

The second information may include definition information for defining input and output of a program module constituting a part of the user program 22. In this case, a language conversion unit 44 may convert a text code included in the response statement received from the LLM server 100 into a ladder diagram that includes invoking the program module.

A prompt generation unit 42 generates a prompt in natural language for causing the LLM server 100 to generate the text code corresponding to the ladder diagram based on the first information, the second information, and the third information received by the information reception unit 41.

An LLM interface 43 controls the communication unit 13 to transmit the prompt generated by the prompt generation unit 42 to the LLM server 100. In addition, the LLM interface 43 controls the communication unit 13 and receives the response statement corresponding to the prompt from the LLM server 100.

The language conversion unit 44 converts the text code included in the response statement received via the LLM interface 43 into a ladder diagram or a motion flow.

The prompt generation unit 42 creates a prompt for obtaining a ladder diagram or a motion flow desired by the user. In order for the LLM server 100 to create an appropriate response statement, fourth information for constraining the response statement may be required for the prompt. For example, when the text code included in the response statement is input to the language conversion unit 44, the language conversion unit 44 needs to be able to convert the text code into a ladder diagram desired by the user. Therefore, the fourth information constrains the response statement, and thus, the LLM server 100 can create an appropriate response statement. As described above, the prompt generation unit 42 may create the fourth information that constrains the text code included in the response statement to be suitable for the conversion into the ladder diagram by the language conversion unit 44, and add the fourth information to the prompt.

The fourth information may be a template of the text code in the general-purpose programming language included in the template 25. The fourth information may be a candidate for a command set including a plurality of commands. The fourth information may include constraint information for constraining the text code so as to invoke the program module from the ladder diagram. The program module included in the user program 22 may be a program module that executes access to a predetermined file. In this case, the constraint information may include path information necessary for accessing a predetermined file. The program module may be a program module that executes access to a predetermined database. In this case, the constraint information includes information necessary for accessing a predetermined database. The program module may be a program module that executes access to a predetermined FTP server. In this case, the constraint information includes address information necessary for accessing a predetermined FTP server.

The PLC system 1 may include the motion unit such as the motor driver 4. In this case, the fourth information may include a point parameter indicating movement coordinates of a control target in the motion unit.

In addition, the fourth information may include information designating a logical operation executed in the ladder diagram, information designating a timer referred to in the ladder diagram, a counter referred to in the ladder diagram, or information designating a special relay referred to from the ladder diagram.

The fourth information may be written in a meta-language used to define a context-free grammar.

A library conversion unit 47 may convert each of a plurality of program components (example: function block, function, and the like) usable in the ladder program according to the ladder diagram into library functions written in the general-purpose programming language. In this case, the fourth information may include a plurality of library functions converted by the library conversion unit 47. The program components may include not only existing component groups prepared in advance in the development environment (that is, prepared by a manufacturer of the PLC) but also component groups prepared by the user. Examples of components prepared in the development environment include a command word (example: FMOV command), a built-in function block (example: timer function block), a built-in function, and a device map (information indicating device assignment). Examples of components prepared by the user include a user function block, a user function, a communication setting (Ethernet/IP communication, PROFINET communication, and FTP communication), and a motion setting (axis configuration, point parameter, G code, and cycle control information). In general, these component groups for the ladder program have not been trained on by the LLM server 100. Thus, the library conversion unit 47 may convert these component groups into a library of the general-purpose programming language.

The fourth information may include constraint information for constraining the text code to be written by using only bit operations and four arithmetic operations. The bit operation in the general-purpose language can be converted into contacts in a ladder program. The four arithmetic operations in the general-purpose language can be converted into operation commands in the ladder program. The library functions in the general-purpose language can be converted into the component groups in the ladder program.

The fourth information may include constraint information indicating that the specification of the ladder program according to the ladder diagram is constrained by the language usage expression format. For example, the language usage expression format may be Extended Backus-Naur form (EBNF).

A first text code included in a first response statement received from the LLM server 100 by the LLM interface 43 may lack sufficient information. In this case, the language conversion unit 44 fails to convert the first text code into the ladder diagram. Therefore, a message output unit 45 may output a message prompting the user to input the insufficient information to the display unit 7. The prompt generation unit 42 generates a prompt including information additionally input by the user. The LLM interface 43 may transmit the prompt generated by the prompt generation unit 42 to the LLM server 100 and receive a second response statement corresponding to the prompt from the LLM server 100.

The language conversion unit 44 converts the second text code included in the second response statement received via the LLM interface 43 into the ladder diagram. The ladder language is not a language written only in text, but is a language written in a graph. Thus, it is difficult to directly convert the text code written in the general-purpose language into the ladder diagram. On the other hand, the ladder diagram is converted into a mnemonic, transferred to the basic unit 3, and converted into a machine code in the basic unit 3. The mnemonic is written in text. Therefore, the language conversion unit 44 converts the text code written in the general-purpose language into the mnemonic, and converts the mnemonic into the ladder diagram. As described above, the text code written in the general-purpose language can be easily converted into the ladder diagram through the mnemonic.

An error detection unit 46 detects a program error in the ladder diagram or the text code. The prompt generation unit 42 may create a prompt for requesting the LLM server 100 to provide a correction suggestion for resolving the program error. The LLM interface 43 may transmit this prompt to the LLM server 100 and receive a correction suggestion corresponding to the prompt from the LLM server 100. The user may correct the user program 22 according to the correction suggestion. Alternatively, the correction suggestion may be the response statement including the text code corrected such that no error occurs. In this case, the language conversion unit 44 converts the text code included in the response statement received via the LLM interface 43 into the ladder diagram.

Incidentally, a graphical expression (ladder diagram) that can be converted from the mnemonic may not be uniquely determined. Therefore, in the fourth information, the specification of the ladder program according to the ladder diagram may include a constraint according to the Extended Backus-Naur form (EBNF). As a result, a graphical expression (ladder diagram) that can be converted from the mnemonic can be uniquely determined. As described above, this constraint is a grammar definition format for causing the LLM server 100 to generate the mnemonic that can be necessarily converted into the ladder diagram.

### <Sequence>

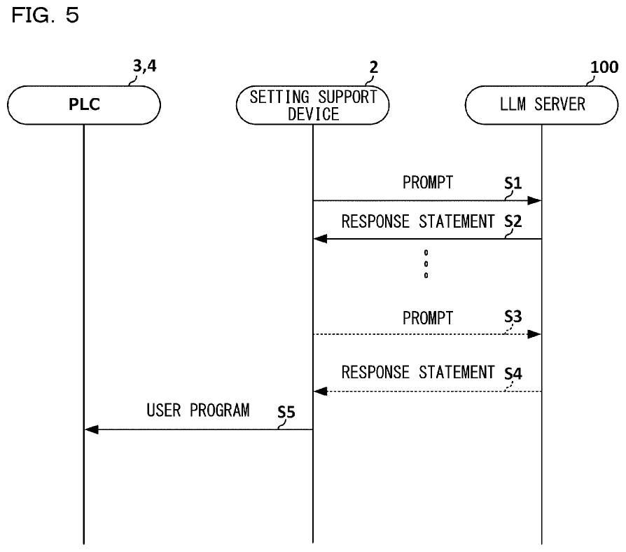

FIG. 5 illustrates a series of methods from the creation to the transfer of the user program 22.

In S1, the PC 2, which is the setting support device, creates a prompt based on information (example: processing content realized by the user program 22, the symbol definition 24 for the input device, the output device, or the like, the configuration information 23 of the PLC system 1, the library function converted into the general-purpose language, or the like) input from the user, and transmits the prompt to the LLM server 100. The LLM server 100 receives a prompt from the PC 2.

In S2, the LLM server 100 creates a program (example: text code such as mnemonic) in the general-purpose language according to a prompt, and transmits the response statement including the program to the PC 2. The PC 2 receives the response statement from the LLM server 100.

The transmission and reception of the prompt in S3 and the transmission and reception of the response statement in S4 are optional. This is because the transmission and reception of the prompt and the response statement may be executed two or more times. As the user program 22 becomes more complicated, the number of times of the transmission and reception of the prompt and the response statement can increase. For example, the CPU 11 may divide the processing content of the user program 22 into a plurality of portions, execute the transmission and reception of the prompt and the response statement for every portion, and combine the portions to complete the user program 22. The text code included in the response statement cannot be converted into the ladder diagram. In this case, the CPU 11 may execute the creation and transmission of a prompt for replenishing insufficient information and reception of the response statement. At this time, the CPU 11 may create and transmit a prompt for requesting the LLM server 100 to create a message (inquiry) for prompting the user to replenish information. The PC 2 may display a message included in the corresponding response statement on the display unit 7 to prompt the user to input additional information. Alternatively, the CPU 11 may detect an error of the user program 22, create a prompt for requesting the LLM server 100 to correct the text code to resolve the error, including an error message and the text code, and receive a correction suggestion from the LLM server 100. Note that the error may be detected by a debugger function (an example of the error detection unit 46) included in the setting software 21. The error detection unit 46 may execute a simulation of the user program 22 to search for a bug that is not detected by a debugger. As described above, S1 to S4 may be repeated several times as necessary. In addition, the CPU 11 may allow the user to manually edit the user program 22 by operating the operation unit 8 between S1 and S4 or after S4. In S5, the PC 2 transfers the completed user program 22 to the PLC (the basic unit 3 or the motor driver 4). The program execution unit 36 of the basic unit 3 executes the user program 22.

### <Flowchart>

### (1) Basic Processing

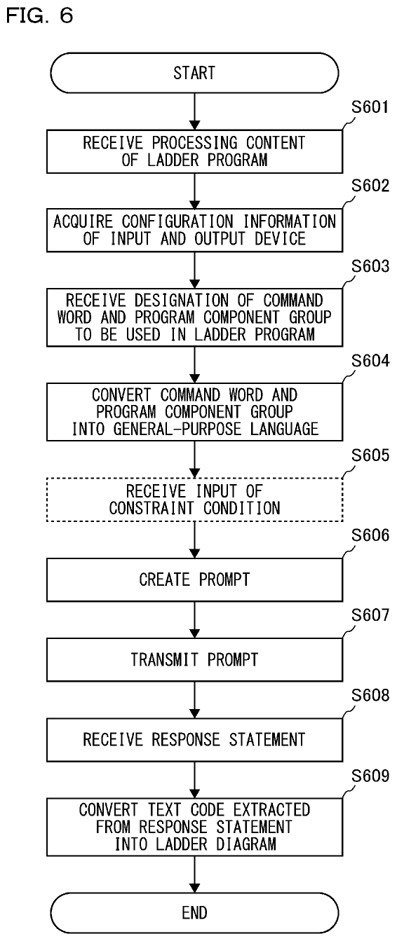

FIG. 6 illustrates a method for creating the user program 22 executed by the CPU 11 in accordance with the setting software 21. A ladder program is adopted as an example of the user program 22.

In step S601, the CPU 11 (information reception unit 41) receives the processing content of the ladder program. The user operates the operation unit 8 to input the processing content of the ladder program. At this time, the display unit 7 may display a user interface including a dialog or the like prompting input of the processing content.

In S602, the CPU 11 (information reception unit 41) acquires configuration information of the input and output device connected to the PLC. The setting software 21 creates in advance the configuration information 23 indicating a model code of the basic unit 3 constituting the PLC system 1, a model code of the input and output device (example: I/O unit, analog input unit, analog output unit, communication unit, and motor drivers 4a to 4c) connected to the basic unit 3, a connection position, and the like based on the user input. Accordingly, the CPU 11 may read the configuration information 23 from the storage device 12.

In S603, the CPU 11 (information reception unit 41) receives designation of a command word (example: FMOV command) in a ladder language and a program component group (example: function block to be pasted to the ladder diagram) to be used in the ladder program. The user inputs these designations by operating the operation unit 8. At this time, the display unit 7 may display a user interface including a dialog or the like prompting the input of the designation.

In S604, the CPU 11 (library conversion unit 47) converts the designated command words and component groups into the general-purpose language. As will be described later, the library conversion unit 47 may access an external database (DB) to acquire a command word in the general-purpose language corresponding to a command word in the ladder language. The library conversion unit 47 may access the external database (DB) to acquire the component group (example: library function) in the general-purpose language corresponding to the component group (example: function block) in the ladder language.

In S605, the CPU 11 (information reception unit 41) receives an input of a constraint condition (the fourth information described above). The user inputs the constraint condition by operating the operation unit 8. At this time, the display unit 7 may display a user interface including a dialog or the like that prompts input of the constraint condition.

In S606, the CPU 11 (prompt generation unit 42) creates a prompt for requesting the LLM server 100 to create a program in the general-purpose language that is a source of the ladder program. This prompt includes the processing content of the ladder program, the configuration information 23, the command words and component groups after conversion, and the constraint condition. Note that the constraint condition cannot be included as long as the processing content of the ladder program is simple.

In S607, the CPU 11 (LLM interface 43) transmits the prompt generated by the prompt generation unit 42 to the LLM server 100.

In S608, the CPU 11 (LLM interface 43) receives the response statement that is the response to the prompt from the LLM server 100.

In S609, the CPU 11 (language conversion unit 44) extracts the text code from the response statement and converts the text code into the ladder diagram. The CPU 11 may display the ladder diagram on the display unit 7, receive an editing instruction such as fine correction of the ladder diagram from the user, and edit the ladder diagram.

### (2) Detailed Processing

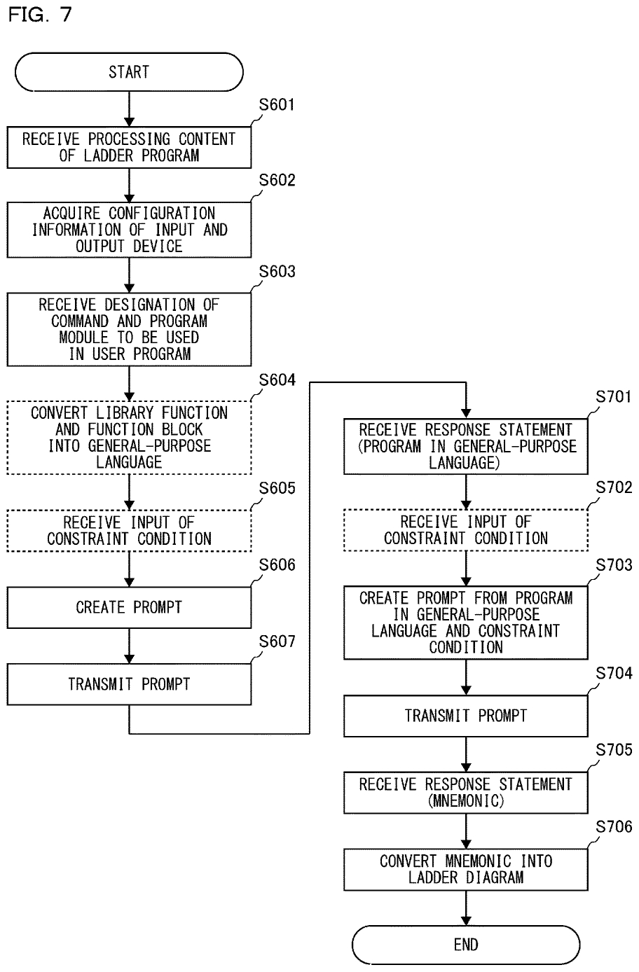

FIG. 7 illustrates a method for creating the user program 22 executed by the CPU 11 in accordance with the setting software 21. Of the steps illustrated in FIG. 7, the steps already described in FIG. 6 are denoted by the same reference numerals, and the description thereof will be omitted. Here, ladder program creation processing is divided into two stages. A first stage is a stage of creating a program in the general-purpose language. A second stage is a stage of creating the mnemonic from the program in the general-purpose language. As described above, it is difficult to directly convert the program (text code) in the general-purpose language into the ladder diagram. Therefore, the program (text code) in the general-purpose language is converted into the mnemonic, and the mnemonic is converted into the ladder diagram.

When the prompt for the program in the general-purpose language is transmitted to the LLM server 100 in S607, the CPU 11 proceeds from S607 to S701.

In S701, the CPU 11 (LLM interface 43) receives the response statement including the program (text code) in the general-purpose language from the LLM server 100.

In S702, the CPU 11 (information reception unit 41) optionally receives the input of the constraint condition. For example, the constraint condition may include a condition that the specification of the ladder program according to the ladder diagram is to be in the Extended Backus-Naur form (EBNF). As described above, this constraint is effective in a case where the mnemonic cannot be uniquely converted into the ladder diagram.

In S703, the CPU 11 (prompt generation unit 42) creates a prompt for generating the mnemonic including the program in the general-purpose language and the constraint condition (optional).

In S704, the CPU 11 (LLM interface 43) transmits the prompt generated by the prompt generation unit 42 to the LLM server 100.

In S705, the CPU 11 (LLM interface 43) receives the response statement to the prompt from the LLM server 100. The response statement includes the mnemonic.

In S706, the CPU 11 (language conversion unit 44) extracts the mnemonic from the response statement and converts the mnemonic into the ladder diagram.

### (3) Error Resolution Method

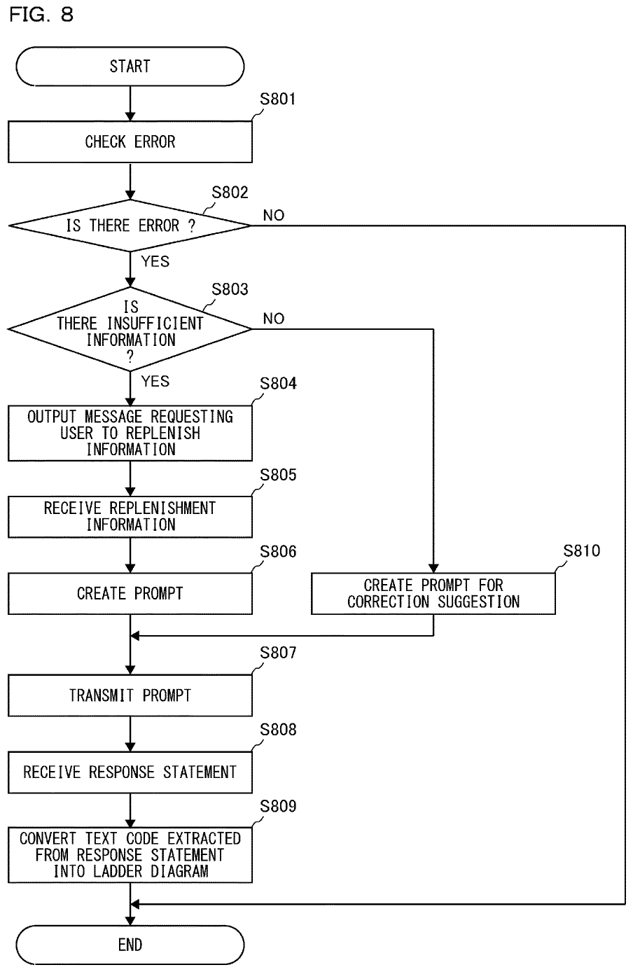

FIG. 8 illustrates an error resolution method of the user program 22 executed by the CPU 11 in accordance with the setting software 21. The error resolution method may be executed for the program in the general-purpose language or may be executed for the mnemonic. As an example, it is assumed that detection is executed for the generated program in the general-purpose language.

In S801, the CPU 11 (error detection unit 46) checks the error of the program in the general-purpose language created by the LLM server 100. Here, an error that hinders compilation of the program in the general-purpose language, such as a syntax error, may be checked.

In S802, the CPU 11 (error detection unit 46) determines whether or not there is an error in the program in the general-purpose language based on an execution result of error check. When there is no error in the program of the general-purpose language, the CPU 11 ends the error resolution method according to FIG. 8. When there is an error in the program in the general-purpose language, the CPU 11 proceeds from S802 to S803.

In S803, the CPU 11 (error detection unit 46) determines whether or not there is insufficient information to be provided to the LLM server 100. For example, the error detection unit 46 may determine whether or not there is insufficient information based on the message from the LLM server 100 or the result of the error check included in the response statement. In a case where there is insufficient information, the CPU 11 proceeds from S803 to S804. In a case where there is no insufficient information, that is, in a case where the error is another cause, the CPU 11 proceeds from S803 to S810.

In S804, the CPU 11 (message output unit 45) outputs a message requesting the user to replenish the information to the display unit 7. This message may include an explanatory statement describing what additional information is required. The explanatory statement may include, for example, information indicating the content of the error. The message output unit 45 may transmit a prompt for creating such an inquiry message to the LLM server 100 and receive the inquiry message as the response statement.

In S805, the CPU 11 (information reception unit 41) receives the replenishment information input by the user through the operation unit 8.

In S806, the CPU 11 (prompt generation unit 42) creates a prompt for resolving the error of the program in the general-purpose language based on the replenishment information.

In S807, the CPU 11 (LLM interface 43) transmits the created prompt to the LLM server 100.

In S808, the CPU 11 (LLM interface 43) receives the response statement (including the corrected program in the general-purpose language) from the LLM server 100.

In S809, the CPU 11 (language conversion unit 44) converts the text code extracted from the response statement, that is, the corrected program of the general-purpose language into the ladder diagram.

As described above, in a case where there is no insufficient information, the CPU 11 proceeds to S810. In S810, the CPU 11 (prompt generation unit 42) creates the prompt for requesting the LLM server 100 to provide the correction suggestion of the program in the general-purpose language, and proceeds to S807.

### <Another Sequence>

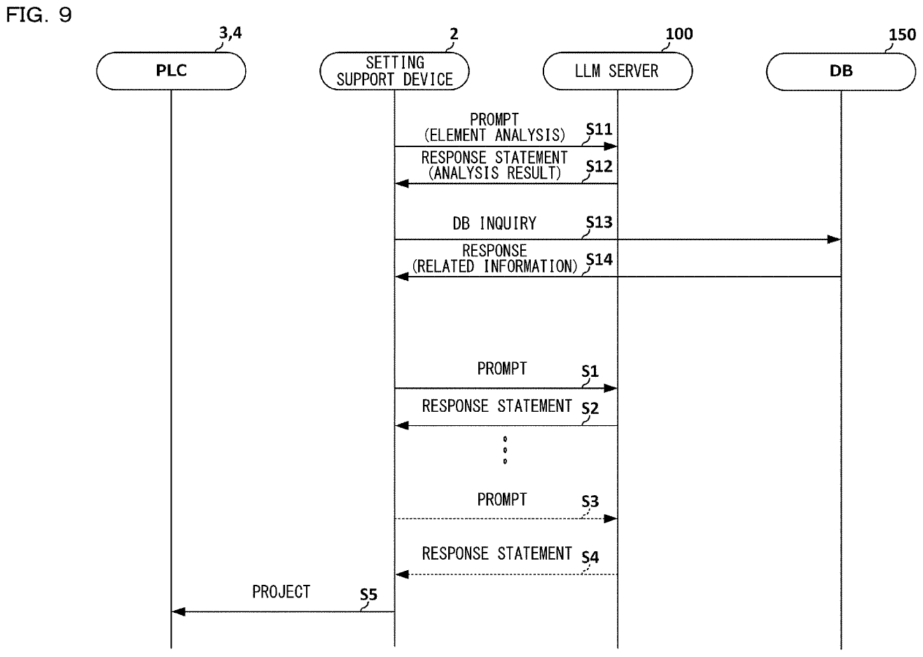

FIG. 9 illustrates a modification of the sequence illustrated in FIG. 5. In FIG. 9, the same reference numerals are assigned to the steps already described in connection with FIG. 5. In this example, S11 to S14 are added before S1. A DB 150 is a computer that provides a database service. The DB 150 may be connected to the PC 2 via the Internet, for example. The CPU 11 can communicate with the DB 150 via the communication unit 13. Since the DB 150 needs to comprehensively store information on the PLC system 1, the DB may be operated by a vendor that manufactures the PLC system 1.

In S11, the PC 2 transmits, to the LLM server 100, a prompt for requesting the LLM server 100 to perform element analysis of the processing content of the program or the mnemonic in the general-purpose language input by the user through the operation unit 8. The LLM server 100 receives the prompt and executes the element analysis based on the prompt. As a result, text written in the natural language is decomposed into a plurality of elements. For example, it is assumed that the processing content is “it is desired to rotate axis 1 clockwise by 180 degrees.” In this case, the result of the element analysis is “axis 1, clockwise direction, 180-degree rotation”.

In S12, the LLM server 100 creates the response statement including the result of the element analysis, and transmits the response statement to the PC 2. The PC 2 receives the response statement from the LLM server 100.

In S13, the PC 2 extracts a plurality of elements from the response statement, creates a DB inquiry (query) for obtaining related information for the plurality of elements, and transmits the DB inquiry to the DB 150. The DB inquiry includes, for example, “axis 1, clockwise direction, 180-degree rotation” which is the result of the element analysis. When the DB inquiry is received from the PC 2, the DB 150 searches the database and acquires the related information. For example, in a case where the DB inquiry includes “axis 1, clockwise direction, 180-degree rotation”, a search for the related information is executed for each element. As a result, “point parameter 1: rotation of 180 degrees clockwise, axis setting information of axis 1, and the like” is acquired as the related information.

In S14, the PC 2 receives the response statement including the related information from the DB 150. Thereafter, the PC 2 creates a prompt including the related information, and transmits the prompt to the LLM server 100. As described above, the amount of information that the user needs to input is reduced by using the DB 150. That is, the burden on the user can be reduced.

Note that, in a case where the setting software 21 has an element analysis function for the text written in the natural language, S11 and S12 are unnecessary.

### Specific Examples

Illustrative examples of the ladder program, the prompt, the response statement, and the like are described below.

### (Case i) Creation Example of Ladder Program for Controlling Motion Unit

### (1) Prompt

The prompt includes, for example, the following text.

“You are provided with the following four pieces of information.
First information regarding the input and output device connected to the programmable logic controller
Second information regarding at least one of the command or the program module to be used in the control program
Third information indicating the content of the control program
Fourth information for ensuring that the text code included in the response statement corresponds to the ladder diagram

In response to the third information and in accordance with the first information, the second information, and the fourth information, answer step by step.”

### (1-1) First Information

The first information may include unit configuration information of an extension unit such as the basic unit 3 or the motor driver 4. As an example, the configuration information of the motion unit is illustrated.
Leading relay number: R34000
Leading DM number: DM10300
Axis 1 positioning control start relay: R34200
Axis 1 positioning control start completion relay: R40800
Axis 1 positioning completion relay: R40802
Axis 1 positioning completion clear relay: R34202
Axis 1 positioning start point number: #2100
Axis 1 positioning control start completion code: #4050

The following pieces of information may be provided as axis information of this unit.
Product series: SV2
Axis number: 1
Axis comment: None
Station address: 42
Extension address: 0
Point parameters:
No1
Rotate clockwise by 90°
No2
Rotate counterclockwise by 90°
No3
Rotate clockwise by 180°
No4
Rotate counterclockwise by 180°

### (1-2) Second Information

An example of the second information is as follows.
Express the scan using while (true).
Do not define local variables within the scan (within the while statement).

At this time, do not use any functions other than APIs listed below. Do not use printf, either.
Acquisition of current time: extern void GetTime(time_t& time);
Greater-than comparison: extern bool GT(int a, int b);
Equality comparison: extern bool EQ(int a, int b);
State determination: extern bool LD(int value);
State determination (inverted logic): extern bool LDB(int value);
Reflect immediately preceding determination: extern bool OUT(int value);
Count-up: extern void INC(int& value);
Value assignment: extern void MOV(int from, int& to);
AND-condition determination: extern bool AND(bool a, bool b);
OR-condition determination: extern bool OR(bool a, bool b);
Always execute: extern bool alwaysOn;

### (1-3) Third Information

An example of the third information is “I want to rotate axis 1 clockwise by 180 degrees.”

### (1-4) Fourth Information

The fourth information includes the following pieces of information.
Additional information: Start operation of axis 1 at point No. 5.
Motion unit setting information
Leading relay number: R30000
Leading DM number: DM10000
Axis 1 positioning control start relay: R30200
Axis 1 positioning control start completion relay: R36800
Axis 1 positioning completion relay: R36802
Axis 1 positioning completion clear relay: R30202
Axis 1 positioning start point number: #2100
Axis 1 positioning control start completion code: #4050
Program for starting operation of Axis 1 at Point No. 5 (C language)

```
      CONDITIONAL_EXECUTION(LD(MR000),OUT(R30000));
      CONDITIONAL_EXECUTION(LD(MR000),OUT(R30505));
      /* Set the positioning start point number of axis 1 to 5, and turn ON the positioning
control start relay */
      CONDITIONAL_EXECUTION(LD(Always),MOV(5,@DM100));
      CONDITIONAL_EXECUTION(LDP(MR001),UWRIT(1,2100,@DM100,1));
      CONDITIONAL_EXECUTION(AND(OR(LDP(MR002),LD(R30200)),AND(LD(R36
600),AND(LDB(R36800),LDB(R36903)))),OUT(DR30200));
      /* Read the positioning control start completion code into EMO */
      CONDITIONAL_EXECUTION(LD(R36800),UREAD(1,4050,EM0,1));
      CONDITIONAL_EXECUTION(AND(LD(R36800),NEQ(EM0,0)),SET(@MR000));
      /* When the positioning completion relay is turned ON, turn ON the positioning
completion clear relay */
      CONDITIONAL_EXECUTION(LD(R36802),OUT(R30202));
```

Further, the fourth information may include the following constraints.

“In particular, utilize AND/OR so that if statements are not nested.

Further, in the program, use the following macro instead of such if statements.

```
      #define CONDITIONAL_EXECUTION((CONDITION), (EXECUTION)) if
(CONDITION) EXECUTION;
      Write portions that are always executed, for example, as
CONDITIONAL_EXECUTION(EQ(1, alwaysOn),...);, so that the macro is used once per
statement.
      In the arguments (CONDITION/EXECUTION) of CONDITIONAL_EXECUTION, do
not use CONDITIONAL_EXECUTION.
```

Within the scan (within the while statement), do not define local variables, and directly write the processing logic in the arguments of CONDITIONAL_EXECUTION.

From the generated program, extract and output only the portions including CONDITIONAL_EXECUTION.

Further, convert this text as follows and generate and output text that does not include

```
AND/OR/CONDITIONAL_EXECUTION.
      AND(X,Y) => XY
      OR(X,Y) => [X,Y]
      CONDITIONAL_EXECUTION(X,Y) => XY
```

Append a semicolon to the end of each statement.

Ensure that the output result satisfies the following EBNF.

# L5KPaerser
## Tokenizer
First, decompose a character string in accordance
with the following rules.
| Separator | Identifier |
| --- | --- |
| ( | lp |
| ) | rp |
| [ | lb |
| ] | rb |
|, | cm |
| ; | sc |
| from “ to the next ” | dq (including spaces) |
| from ‘ to the next ’ | sq (including spaces) |
| while other tokens continue | tk (separated by spaces) |
| space | skipped |

Error detection & messages

If a character string is not closed with DQ and SQ, output “The end of the character string cannot be found.”

```
      ## EBNF
      FROM | TO | Error detection | Error message
|
      | --- | --- | --- | ---
|
      | INPUTTEXT  | RUNG+ | | |
|
      | RUNG | RUNGELEMENT sc | sc missing | “;” of
terminating cannot be found. |
      | RUNGELEMENT | sc | |
|
      | |SERIALBLOCK | |
|
      | SERIALBLOCK | SERIALELEMENT+ | |
|
      | SERIALELEMENT | NODE | |
|
      | | PARALLELBLOCK | |
|
      | PARALLELBLOCK | lb SERIALBLOCK (cm SRIALBLOCK?)+ rb | insufficient
BLOCK or rb missing | “]” cannot be found. |
      | NODE | OPERATION lp OPERAND? (cm OPERAND?)* rp | lp missing or rp
missing |“(“ cannot be found. or ”)” cannot be found. |
      | OPERATION | tk | tk missing | command
cannot be found. |
      | OPERAND | dq | |
|
      | | sq | |
|
      | | EXPRESSION | | |
      | MODIFIER | tk | |
|
      | EXPRESSION | token + other than “cm” and “rp not paired with lp” |
| |”
```

### (2) Response Statement

When the above prompt is transmitted to the LLM server 100, the following response statement (mnemonic) is obtained.
LD (MR000) OUT (R34000);
LD (MR000) OUT (R34200);
LD (alwaysOn) MOV (3,@DM100);
LDP (MR001) UWRIT (1,2100,@DM100,1);

### [LD (MR002),LD (R34200)] LDB (R40600) LDB (R40800) LD (R40903) OUT (DR34200);

LD (R40800) UREAD (1,4050,EM0,1);
LD (R40800) NEQ (EM0,0) SET (@MR000);
LD (R40802) OUT (R34202);

### (3) Ladder Diagram

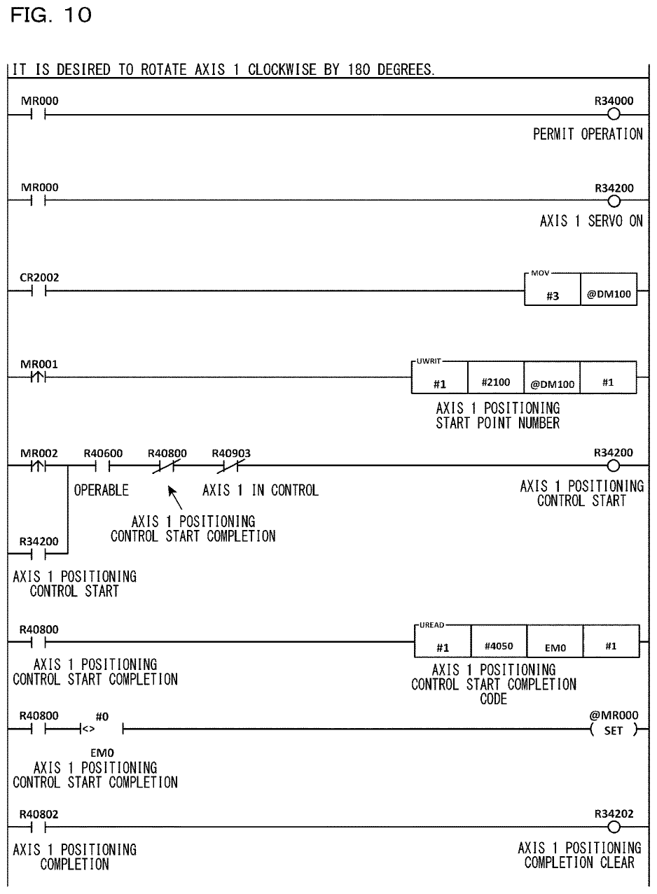

FIG. 10 illustrates the ladder diagram converted from the response statement. It can be seen that the mnemonic included in the response statement and the ladder diagram match each other. According to FIG. 1, when MR000 is turned on, the operation is permitted. In addition, when MR000 is turned on, the servo of axis 1 in motor driver 4 is turned on. CR2002 is a relay device that is always ON. 3 is substituted into the DM100 by a MOV command. On the rising edge of MR001, 2100 is set as a positioning start point number of axis 1 by a UWRIT command. When MR002 rises, or when the positioning of axis 1 is started and the motor driver 4 is operable, and positioning control of axis 1 has not been started and axis control is not in process, the positioning control of axis 1 is started. When the start of the positioning control is completed, a completion code is written into EM0 by the UREAD command. Thereafter, after the start of the positioning control is completed, the positioning of axis 1 is completed.

### (Case ii) In Case of Function Block

In the above-described embodiment, not only the ladder diagram but also function blocks written in the ladder diagram can be created with the assistance of the LLM server 100. Hereinafter, as an example, a method for creating a function block in which a comma-separated character string is cut by comma separation, the character string is converted into a numeric value, and stored in an array is described.

### (1) Prompt

“You are provided with the following four pieces of information.
First information regarding the input and output devices connected to the programmable logic controller
Second information regarding at least one of the command and the program module to be used in the control program
Third information indicating the content of the control program Fourth information for enabling the text code included in the response statement to correspond to the ladder diagram

In response to the third information and in accordance with the first information, the second information, and the fourth information, answer step by step.”

### (1-1) First Information

None

### (1-2) Second Information

Information I

Express the scan using while (true).

Do not define local variables within the scan (within the while statement).
Information II

At this time, do not use any functions other than APIs listed below. Do not use printf, either.
Acquisition of current time: extern void GetTime(time_t& time);
Greater-than comparison: extern bool GT(int a, int b);
Equality comparison: extern bool EQ(int a, int b);
State determination: extern bool LD(int value);
State determination (negative logic): extern bool LDB(int value);
Reflect immediately preceding determination: extern bool OUT(int value);
Count-up: extern void INC(int& value);
Value assignment: extern void MOV(int from, int& to);
AND-condition determination: extern bool AND(bool a, bool b);
OR-condition determination: extern bool OR(bool a, bool b);
Always execute: extern bool alwaysOn;

Search for a position at which a character string F appears in a character string S from a start character position and store the result in D: extern void SFIND (char *S, char *F, short *D, short start);
/**
*@brief Cut a designated number of characters from a left end (beginning) of a character string.
*S: Designate a source character string from which characters are to be cut, or a storage destination thereof
*D: Designate a storage destination of the cut character string
*n: Designate the number of characters (number of bytes) to be cut (0 to 1999)
*/
extern void SLEFT (char *S, char *D, short n);
/**
*@brief Convert a decimal ASCII character string into a numeric value.
*ascii: Designate a storage destination of the decimal ASCII character string to be converted into BIN data
*num: Designate a storage destination of converted BIN data
*/extern void RDASC (char *ascii, int *num);

### (1-3) Third Information

“Cut a comma-separated character string by comma separation, convert the character string into a numeric value, and store the numeric value in an array.”

### (1-4) Fourth Information

“In particular, utilize AND/OR so that if statements are not nested.

Further, in the program, use the following macro instead of such if statements. #define CONDITIONAL_EXECUTION ((CONDITION), (EXECUTION)) if (CONDITION) EXECUTION;

Write portions that are always executed, for example, as
CONDITIONAL_EXECUTION(EQ(1, alwaysOn), . . . );, so that the macro is used once per statement.

In the arguments (CONDITION/EXECUTION) of CONDITIONAL_EXECUTION, do not use CONDITIONAL_EXECUTION.

Within the scan (within the while statement), do not define local variables, and directly write the processing logic in the arguments of CONDITIONAL_EXECUTION.

From the generated program, extract and output only the portions including

```
CONDITIONAL_EXECUTION.
      Further, convert the text as follows and generate and output text that does not include
AND/OR/CONDITIONAL_EXECUTION.
      AND(X,Y) => XY
      OR(X,Y) => [X,Y]
      CONDITIONAL_EXECUTION(X,Y) => XY
```

Append a semicolon to the end of each statement.

Ensure that the output result satisfies the following EBNF.

# L5KPaerser
## Tokenizer
First, decompose a character string in accordance
with the following rules.
| Separator | Identifier |
| --- | --- |
| ( | lp |
| ) | rp |
| [ | lb |
| ] | rb |
|, | cm |
| ; | sc |
| from “ to the next ” | dq (including spaces) |
| from ‘ to the next ’ | sq (including spaces) |
| while other tokens continue | tk (separated by spaces) |
| space | skipped |

Error Detection & Messages

If a character string is not closed with DQ and SQ, output “The end of the character string cannot be found.”

```
      ## EBNF
      FROM | TO | Error detection | Error message
|
      | --- | --- | --- | ---
|
      | INPUTTEXT  | RUNG+ | | |
|
      | RUNG | RUNGELEMENT sc | sc missing | “;” of
terminating cannot be found. |
      | RUNGELEMENT | sc | |
|
      | | SERIALBLOCK | |
|
      | SERIALBLOCK | SERIALELEMENT+ | |
|
      | SERIALELEMENT | NODE | |
|
      | | PARALLELBLOCK | |
|
      | PARALLELBLOCK | lb SERIALBLOCK (cm SRIALBLOCK?)+ rb | insufficient
BLOCK or rb missing | “]” cannot be found. |
      | NODE | OPERATION lp OPERAND? (cm OPERAND?)* rp | lp missing or rp
missing | “(“ cannot be found. or ”)” cannot be found. |
      | OPERATION | tk | tk missing | command
cannot be found. |
      | OPERAND | dq | |
|
      | | sq | |
|
      | | EXPRESSION | | |
      | MODIFIER | tk | |
|
      | EXPRESSION | token + other than “cm” and “rp not paired with lp” |
| |”
```

### (2) Response Statement

LD (alwaysOn) SFIND (inputString, “,”, &commaPosition, index);
LD (alwaysOn) SLEFT (inputString, tempString, commmaPosition);
LD (alwaysOn) RDASC (tempString, &number);
LD (alwaysOn) MOV (number, array [index]);
LD (alwaysOn) INC (index);

### (3) Ladder Diagram

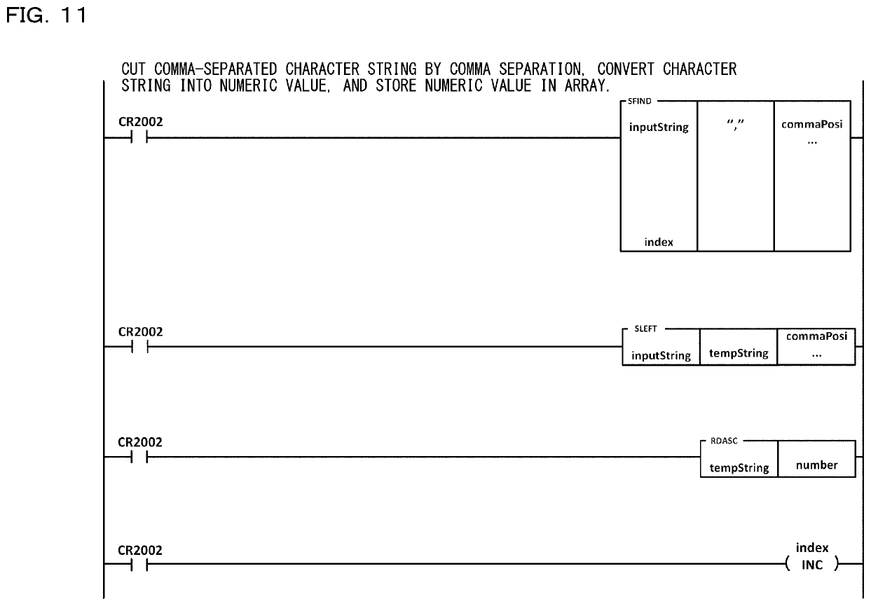

FIG. 11 illustrates the generated function block. SFIND is a command word for executing a character string search. SLEFT is a command word for extracting characters from a left side of a character string. RDASC is a command word for converting between decimal numbers and ASCII characters. As a result, the comma-separated character string is cut by the comma separation, and the cut character string is converted into the numeric value and stored in the array. As described above, the function block can convert characters from the beginning of a given character string up to a comma into a numeric value. The user may appropriately correct the generated function block and finish the function block so that a function desired by the user is realized.

(Case iii) Case Where Ladder Diagram and Program Module are Separately Generated

Hereinafter, it is described that the ladder diagram and the program module are individually generated in a case where the program module (example: function block) is read from the ladder diagram.

### (1) Prompt

(1-1) First information

“You are provided with the following four pieces of information.
First information regarding the input and output device connected to the programmable logic controller
Second information regarding at least one of the command or the program module to be used in the control program
Third information indicating the content of the control program
Fourth information for enabling the text code included in the response statement to correspond to the ladder diagram

In response to the third information and in accordance with the first information, the second information, and the fourth information, answer step by step.”

### (1-2) Second Information

### Information I

Express the scan using while (true).

Do not define local variables within the scan (within the while statement).

### Information II

At this time, do not use any functions other than APIs listed below. Do not use printf, either.
Acquisition of current time: extern void GetTime(time_t& time);
Greater-than comparison: extern bool GT(int a, int b);
Equality comparison: extern bool EQ(int a, int b);
State determination: extern bool LD(int value);
State determination (negative logic): extern bool LDB(int value);
Reflect immediately preceding determination: extern bool OUT(int value);
Count-up: extern void INC(int& value);
extern void MOV(int from, int& to); Value assignment:
AND-condition determination: extern bool AND(bool a, bool b);
OR-condition determination: extern bool OR(bool a, bool b);
Always execute: extern bool alwaysOn;
Search for a position at which a character string F appears in a character string S from a start character position and store the result in D: extern void SFIND(char *S, char *F, short *D, short start);
/**
*@brief Cut a designated number of characters from a left end (beginning) of a character string.
*S: Designate a source character string from which characters are to be cut, or a storage destination thereof
*D: Designate a storage destination of the cut character string
*n: Designate the number of characters (number of bytes) to be cut (0 to 1999)
*/extern void SLEFT(char *S, char *D, short n);
/**
*@brief Convert a decimal ASCII character string into a numeric value.
*ascii: Designate a storage destination of the decimal ASCII character string to be converted into BIN data
*num: Designate a storage destination of converted BIN data
*/extern void RDASC(char *ascii, int *num);

### (1-3) Third Information

“Only when R00 is ON and R100 is OFF, cut a comma-separated character string by comma separation, convert the character string into a numeric value, and store the numeric value in an array.”

### (1-4) Fourth Information

“Constraints and procedures are provided, and implement procedures while keeping the constraints in mind.
Constraint 1:

Utilize AND/OR so that if statements are not nested.
Constraint 2:

In the program, use the following macro instead of such if statements.
#define CONDITIONAL_EXECUTION ((CONDITION), (EXECUTION)) if (CONDITION) EXECUTION
Write portions that are always executed, for example, as CONDITIONAL_EXECUTION(EQ(1, alwaysOn), . . . );, so that the macro is used once per statement.
Constraint 3:

In the arguments (CONDITION/EXECUTION) of CONDITIONAL_EXECUTION, do not use CONDITIONAL_EXECUTION.

In addition, limit processing to be performed in EXECUTION to only one operation.
Constraint 4:

Within the scan (within the while statement), do not define local variables, and directly write the processing logic in the arguments of CONDITIONAL_EXECUTION.
Constraint 5:

Satisfy the following EBNF written in a markdown format.
#L5KPaerser
##Tokenizer

First, decompose a character string in accordance with the following rules.

| Separator | Identifier |
| --- | --- |
| ( | lp |
| ) | rp |
| [ | lb |
| ] | rb |
|, | cm |
| ; | sc |
| from “ to the next ” | dq (including spaces) |
| from ‘ to the next ’ | sq (including spaces) |
| while other tokens continue | tk ( separated by spaces) |
| space | skipped |

Error Detection & Messages

If a character string is not closed with DQ and SQ, output “The end of the character string cannot be found.”

```
      ## EBNF
      FROM | TO | Error detection | Error message
|
      | --- | --- | --- | ---
|
      | INPUTTEXT  | RUNG+ | | |
|
      | RUNG | RUNGELEMENT sc | sc missing | “;” of
terminating cannot be found. |
      | RUNGELEMENT | sc | |
|
      | | SERIALBLOCK | |
|
      | SERIALBLOCK | SERIALELEMENT+ | |
|
      | SERIALELEMENT | NODE | |
|
      | | PARALLELBLOCK | |
|
      | PARALLELBLOCK | lb SERIALBLOCK (cm SRIALBLOCK?)+ rb | insufficient
BLOCK or rb missing | “]” cannot be found. |
      | NODE | OPERATION lp OPERAND? (cm OPERAND?)* rp | lp missing or rp
missing |“(“ cannot be found. or ”)” cannot be found. |
      | OPERATION | tk | tk missing | command
cannot be found. |
      | OPERAND | dq | |
|
      | | sq | |
|
      | | EXPRESSION | | |
      | MODIFIER | tk | |
|
      | EXPRESSION | token + other than “cm” and “rp not paired with lp” |
| |”
```

Perform the following Procedures 1 to 3.
Procedure 1:

Understand the content of the third Information, and, in accordance with Constraints 1 to 4, convert the content into a C-language program and output the program.
Procedure 2:

With respect to the program created in Procedure 1, if there is any portion where the meaning of the processing is discontinuous, add comments in the following formats before and after such portion so that it is recognizable that the portion is separated.
Comment format to be added before the processing: /* [start] function-meaning: meaning of processing */
Comment format to be added after the processing: /* [end] function-meaning: meaning of the processing */
Procedure 2:

From the generated program, extract and output only lines that include CONDITIONAL_EXECUTION or function-meaning.

### Procedure 3:

Convert the text output in Procedure 2 as follows to generate and output text that does not include AND/OR/CONDITIONAL_EXECUTION. At this time, ensure that the output text satisfies Constraint 5.

AND(X,Y) => XY
OR(X,Y) => [X,Y]
CONDITIONAL_EXECUTION(X,Y) => XY

Append a semicolon to the end of each statement.”

### (2) Response Statement

Among the response statements, the response statement for the function block is as described above. Here, it is assumed that the function block is assigned a name of convertCommaSeparatedStringToNumberArray. The response statement corresponding to the ladder diagram is a mnemonic that invokes the function block of convertCommaSeparatedStringToNumberArray. A specific description of the mnemonic is omitted.

### (3) Ladder Diagram

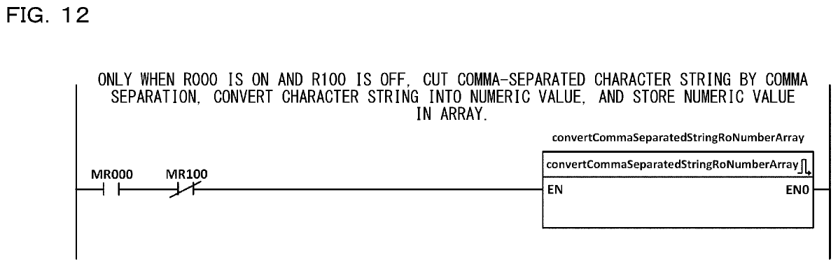

FIG. 12 illustrates an example of the generated ladder diagram. Note that the function block to be generated is as illustrated in FIG. 11. As illustrated in FIG. 12, only when R00 is ON and R100 is OFF, in the function block of convertCommaSeparatedStringToNumberArray is invoked. As a result, by the function block of convertCommaSpearedStringToNumberArray, a comma-separated character string is cut by comma separation, and the cut character string is converted into a numeric value and stored in the array.

### (Case iv) Effectiveness of Designating EBNF

As described above, by designating the EBNF, a response statement including a text code that can be more reliably converted into the ladder diagram can be obtained. Here, in order to verify the usefulness of designating the EBNF, a case where the text code that can be converted into the ladder diagram cannot be obtained in a case where the EBNF is not designated is introduced.
Case A: A case where instruction “simply create ladder.” is given
Case B: A case where instruction “create in natural language and then convert to ladder.” is given

### (1) Regarding Case A

### (1-1) Prompt

“Output a program that satisfies the following requirements. Present a program that can be converted into a ladder diagram by a PLC editor.

Cut a comma-separated character string by comma separation, convert the character string into a numeric value, and store the numeric value in an array.”

### (1-2) Response Statement

“A PLC ladder diagram generally cannot be directly converted into a text-based programming language. However, the function you requested can be implemented in a general-purpose programming language. An example implementation in Python is shown below.

def convert_string_to_numbers(input_string):
# split by commas
string_list = input_string.split(‘,’)
# convert character string to numeric value
number_list = [int(s) for s in string_list]
return number_list
# test
input_string = “1,2,3,4,5”
print(convert_string_to_numbers(input_string)

This program receives a comma-separated character string as input, splits the character string by a comma, converts each character string into a numeric value, and stores the numeric value in an array.

However, it is difficult to perform such an operation in the ladder diagram of the PLC, and it is recommended to use a high-level language (for example, Structured Text, Function Block Diagram, or the like) normally incorporated in a programming environment of the PLC. These languages support more complicated operations such as character string operations and array operations.”

### (1-3) Consideration of Result

In Case A, the LLM server 100 creates a response statement including a Python code because the ladder diagram cannot be output. From this result, in order to create the ladder diagram, it is necessary to create a parser for converting from Python to the ladder diagram, which can be difficult for a typical user.

### (2) Case B

### (2-1) Prompt

“Output a program that satisfies the following requirements through two steps.

Present a program that can be converted into a ladder diagram by a PLC editor.

### Requirements

Cut a comma-separated character string by comma separation, convert the character string into a numeric value, and store the numeric value in an array.”

### Step 1

Create a program in C++ format that satisfies the requirements.

### Step 2

Based on the program created in Step 1 and the requirements, present code that can be converted into a ladder diagram by a PLC editor.

### (2-2) Response Statement

### “Step 1: Program in C++ Language

The following description is a C++ program that takes a comma-separated character string, converts the character string into numeric value, and stores the numeric value in an array.

#include <iostream>
#include <sstream>
#include <vector>
#include <string>
std::vector<int> splitAndConvert(const std::string& str) {
std::vector<int> result;
std::stringstream ss(str);
std::string token;
while (std::getline(ss, token, ‘,’)) {
result.push_back(std::stoi(token));
}
return result;
}
int main( ) {
std::string input = “1,2,3,4,5”;
std::vector<int> numbers = splitAndConvert(input);
for (int num : numbers) {
std::cout << num << std::endl;
}
return 0;
}

### Step 2: PLC Ladder Diagram

A PLC ladder diagram is typically used to express physical inputs and outputs. Accordingly, it is difficult to directly express character string operations and array operations. However, it is possible to express a general program flow.

The following description is an example of the ladder diagram expressing the general flow of the above C++ program. However, the specific implementation depends on a model of the PLC used and the programming environment.

```
      (Start) [----]( )----[/]----(Split and Convert)
[----]( )----[/]----(Store in Array)
[----]( )----[/]----(Output)
      (End) [----]( )----[/]
```

This ladder diagram expresses a flow from “Start” to “End”. “Split and Convert” expresses an operation of splitting a character string and converting the split character string into a numeric value, “Store in Array” expresses an operation of storing the result in an array, and “Output” expresses an operation of outputting the result.”

### (2-3) Consideration of Result

In Case B, a response statement that appears to be correct at first glance is obtained as compared with Case i. However, in practice, this is not a correct ladder diagram.

When [/] written in the response statement is regarded as a contact,
(End) [- - - -]( )- - - -[/]
is inconsistent as the ladder diagram. Conversely, even though this is regarded as a coil, it results in a double coil and is therefore inappropriate. Even though one forcibly attempts to interpret this text as the ladder diagram, in order to convert this text that cannot be understood as such into the ladder diagram, it is still necessary to create a parser. However, this is difficult for the typical user.

As suggested by Cases A and B, in a case where EBNF is not designated, a response statement that is difficult to convert into the ladder diagram may be obtained. Therefore, designating the EBNF can be useful for obtaining a desired response statement in a short time and in a simple manner.

<Technical Idea Derived from Examples>

### Aspect 1

The PC 2 is an example of a program creation support device that supports the creation of the control program used in the programmable logic controller. The CPU 11, the operation unit 8, and the information reception unit 41 may receive, in the natural language, the first information regarding the input and output device connected to the programmable logic controller, the second information regarding at least one of the command or the program module for controlling the input and output device, and the third information indicating the control content realized in combination with the command or the program module. The CPU 11 and the prompt generation unit 42 may generate the prompt in the natural language for generating the text code corresponding to the ladder diagram based on the first information, the second information, and the third information received by the information reception unit 41. The CPU 11, the communication unit 13, and the LLM interface 43 may transmit the prompt generated by the prompt generation unit 42 to a large language model (LLM), and receive a response statement corresponding to the prompt from the large language model. The CPU 11 and the language conversion unit 44 may convert the text code included in the response statement received via the LLM interface 43 into the ladder diagram. Here, the CPU 11 and the prompt generation unit 42 may add, to the prompt, the fourth information for constraining the text code included in the response statement so as to be suitable for the conversion into the ladder diagram by the language conversion unit 44. As a result, it becomes possible for a user who creates the control program used in the programmable logic controller, such as the ladder program, to benefit from the LLM.

### Aspect 2

The fourth information may be the template of the text code in the general-purpose programming language. The template of the text code to be included in the response statement is transmitted to the LLM server 100 in advance, and thus, the LLM server 100 can create the response statement according to the template. As a result, a text code more desired by the user may be obtained.

### Aspect 3

The fourth information may be a candidate for a command set including a plurality of commands. The LLM server 100 is presented with the command set usable in the text code in advance, and thus, the LLM server 100 can generate the text code with the presented command set. As a result, a text code more desired by the user may be obtained.

### Aspect 4

The second information may include definition information for defining the input and output of the program module. The CPU 11 and the language conversion unit 44 may convert the text code into the ladder diagram that includes invoking a program module. As a result, the ladder diagram capable of invoking a program module desired by the user can be generated. Note that the second information may also include the name of the program module and the like.

### Aspect 5

The fourth information may include constraint information for constraining the text code so as to invoke the program module from the ladder diagram. As described above, without the constraint information, it is difficult to uniquely obtain the ladder diagram from the text code. Therefore, the text code (example: mnemonic) to be included in the response statement is limited by the constraint information, and thus, the ladder diagram desired by the user can be obtained.

### Aspect 6

The program module may be a program module that executes access to a predetermined file. In this case, the constraint information includes path information necessary for accessing the predetermined file.

### Aspect 7

The program module may be a program module that executes access to a predetermined database (example: DB 150). The constraint information includes information necessary for accessing the predetermined database (example: network address of the DB 150 and query format).

### Aspect 8

The program module may be a program module that executes access to a predetermined FTP server. FTP is an abbreviation for File Transfer Protocol. The constraint information may include address information necessary for accessing the predetermined FTP server.

### Aspect 9

The programmable logic controller may include a motion unit (example: motor driver 4). The fourth information may include a point parameter indicating movement coordinates of the control target in the motion unit.

### Aspect 10

The fourth information may include information (example: BIT operations, four arithmetic operations) designating a logical operation to be executed in the ladder diagram. As a result, the text code that can be converted into the ladder diagram can be obtained. The fourth information may include information designating a timer referred to in the ladder diagram. As a result, a text code that can be converted into the ladder diagram capable of referring to the timer can be obtained. The fourth information may include a counter referred to in the ladder diagram. As a result, a text code that can be converted into the ladder diagram that can refer to the counter can be obtained. Alternatively, the fourth information may include information designating a special relay referred to from the ladder diagram. As a result, a text code that can be converted into the ladder diagram that can refer to the special relay can be obtained.

### Aspect 11

The first text code included in the first response statement received by the LLM interface 43 may fail to be converted into the ladder diagram due to insufficient information. In this case, the CPU 11, the display unit 7, and the message output unit 45 may function as output means for outputting a message prompting the user to input insufficient information. The prompt generation unit 42 may generate a prompt including information additionally input by the user. The LLM interface 43 may transmit the prompt generated by the prompt generation unit 42 to the large language model and receive the second response statement corresponding to the prompt from the large language model. The language conversion unit 44 may convert the second text code included in the second response statement received via the LLM interface 43 into the ladder diagram. As described above, in a case where an appropriate text code cannot be obtained due to the input insufficient information, it is possible to prompt the user to replenish the input information. As a result, a text code that can be converted into the ladder diagram desired by the user can be obtained.

### Aspect 12

The first information may include role information indicating a role of each of a plurality of input devices (example: IO unit and analog input unit) connected to the programmable logic controller. As a result, the LLM server 100 can generate a text code corresponding to the roles of the plurality of input devices.

### Aspect 13

The role information included in the first information may be reflected in a variable name or a comment in the ladder diagram. As a result, the user can easily confirm whether or not the ladder diagram suitable for the role of the input device is generated by referring to the variable name and the comment described in the ladder diagram. In addition, the user can save time and effort to input the comment to the ladder diagram.

### Aspect 14

The fourth information may be written in the meta-language used to define the context-free grammar. As a result, a probability of obtaining the text code desired by the user can increase.

### Aspect 15

The CPU 11 and the error detection unit 46 may function as detection means for detecting the program error in the ladder diagram or the text code. The prompt generation unit 42 may create a prompt for requesting the large language model to provide the correction suggestion for resolving the program error. As a result, the program error can be resolved early.

### Aspect 16

The CPU 11 and the library conversion unit 47 may function as a second conversion unit that converts each of the plurality of program components usable in the ladder program according to the ladder diagram into the library function written in the general-purpose programming language. In this case, the fourth information may include the plurality of library functions converted by the second conversion unit. The library function usable in the text code is presented to the LLM server 100, and thus, the text code generated by the LLM server 100 is constrained. As a result, the text code desired by the user can be easily obtained.

### Aspect 17

The fourth information may include the constraint information for constraining the text code to be written by using only the bit operations and the four arithmetic operations. As a result, a text code that can be easily converted into the ladder diagram can be easily obtained.

### Aspect 18

The fourth information may include constraint information indicating that the specification of the ladder program according to the ladder diagram is constrained by the language usage expression format. As a result, a text code conforming to the specification of the ladder program can be easily obtained. For example, a text code of a mnemonic that can be converted into the ladder diagram can be easily obtained.

### Aspect 19

The language usage expression format may be Extended Backus-Naur form (EBNF). As a result, a text code that can be converted into the ladder diagram can be easily obtained. For example, a text code of a mnemonic that can be converted into the ladder diagram can be easily obtained.

### Aspect 20

A computer program for supporting creation of a control program used in a programmable logic controller, the computer program causing a computer to execute:
receiving, in natural language, first information regarding an input and output device connected to the programmable logic controller, second information regarding at least one of a command or a program module for controlling the input and output device, and third information indicating a control content realized by the command or the program module;
generating a prompt in the natural language for generating a text code corresponding to a ladder diagram based on the received first information, second information, and third information;
transmitting the generated prompt to a large language model (LLM) and receiving a response statement corresponding to the prompt from the large language model;
converting the text code included in the response statement received from the large language model into a ladder diagram; and
adding, to the prompt, fourth information for constraining the text code included in the response statement to be suitable for conversion into the ladder diagram.

The invention is not limited to the above embodiments, and various modifications and changes can be made within the scope of the spirit of the invention.

What is claimed is:

1. A program creation support device for supporting creation of a control program used in a programmable logic controller, the program creation support device comprising one or more memories configured to store executable units, and one or more processors, operatively coupled to the one or more memories, configured to execute the executable units, the executable units comprising:
an information reception unit configured to receive, in natural language, first information regarding an input and output device connected to the programmable logic controller, second information regarding at least one of a command or a program module for controlling the input and output device, and third information indicating a control content realized in combination with the command or the program module;
a prompt generation unit configured to generate a prompt in natural language for generating a text code corresponding to a ladder diagram based on the first information, the second information, and the third information received by the information reception unit;
a large language model (LLM) interface configured to transmit the prompt generated by the prompt generation unit to an LLM and receive a response statement corresponding to the prompt from the LLM; and
a conversion unit configured to convert a text code included in the response statement received via the LLM interface into a ladder diagram,
wherein the prompt generation unit adds, to the prompt, fourth information for constraining the text code included in the response statement to be suitable for the conversion into the ladder diagram by the conversion unit.

2. The program creation support device according to claim 1, wherein the fourth information is a candidate for a command set including a plurality of commands.

3. The program creation support device according to claim 1,
wherein the second information includes definition information for defining input and output of the program module, and
the conversion unit converts the text code into the ladder diagram that includes invoking the program module.

4. The program creation support device according to claim 1, wherein the fourth information includes constraint information for constraining the text code to invoke the program module from the ladder diagram.

5. The program creation support device according to claim 4,
wherein the program module is a program module that executes access to a predetermined database, and
the constraint information includes information necessary for accessing the predetermined database.

6. The program creation support device according to claim 1,
wherein the programmable logic controller includes a motion unit, and
the fourth information includes a point parameter indicating movement coordinates of a control target in the motion unit.

7. The program creation support device according to claim 1, wherein the fourth information includes information designating a logical operation executed in the ladder diagram, information designating a timer referred to in the ladder diagram, a counter referred to in the ladder diagram, or information designating a special relay referred to from the ladder diagram.

8. The program creation support device according to claim 1, further comprising:
output means for outputting a message prompting a user to input insufficient information in a case where a first text code included in a first response statement received by the LLM interface fails to be converted into the ladder diagram due to the insufficient information,
wherein the prompt generation unit generates a prompt including information additionally input by the user,
the LLM interface transmits the prompt generated by the prompt generation unit to the LLM and receives a second response statement corresponding to the prompt from the LLM, and
the conversion unit converts a second text code included in the second response statement received via the LLM interface into the ladder diagram.

9. The program creation support device according to claim 1, wherein the first information includes role information indicating a role of each of a plurality of input devices connected to the programmable logic controller.

10. The program creation support device according to claim 1, further comprising:
detection means for detecting a program error in the ladder diagram or the text code,
wherein the prompt generation unit creates a prompt for requesting the LLM to provide a correction suggestion for resolving the program error.

11. The program creation support device according to claim 1, further comprising:
a second conversion unit that converts each of a plurality of program components usable in the ladder program according to the ladder diagram into a library function written in a general-purpose programming language,
wherein the fourth information includes a plurality of library functions converted by the second conversion unit.

12. The program creation support device according to claim 1, wherein the fourth information includes constraint information for constraining the text code to be written by using only bit operations and four arithmetic operations.

13. The program creation support device according to claim 1, wherein the fourth information includes constraint information indicating that a specification of a ladder program according to the ladder diagram is constrained by a language usage expression format.

14. The program creation support device according to claim 13, wherein the language usage expression format is Extended Backus-Naur form (EBNF).

15. A computer program product for supporting creation of a control program used in a programmable logic controller, the computer program product having stored thereon instructions that, in response to execution, cause a device comprising one or more processors to perform operations, the operations comprising:
receiving, in natural language, first information regarding an input and output device connected to the programmable logic controller, second information regarding at least one of a command or a program module for controlling the input and output device, and third information indicating a control content realized in combination with the command or the program module;
generating a prompt in natural language for generating a text code corresponding to a ladder diagram based on the received first information, the second information, and the third information;
transmitting the generated prompt to a large language model (LLM) and receiving a response statement corresponding to the prompt from the LLM;
converting a text code included in the response statement received from the LLM into a ladder diagram, and
adding, to the prompt, fourth information for constraining the text code included in the response statement to be suitable for the conversion into the ladder diagram.

16. The computer program product of claim 15, wherein the fourth information includes constraint information indicating that a specification of a ladder program according to the ladder diagram is constrained by a language usage expression format, and wherein the language usage expression format is Extended Backus-Naur form (EBNF).

17. The computer program product of claim 15, the operations further comprising:
converting each of a plurality of program components usable in a ladder program according to the ladder diagram into a library function written in a general-purpose programming language,
wherein the fourth information includes the plurality of converted library functions.

18. The computer program product of claim 15, wherein the operations further comprise:
in a case where a first text code included in a first response statement received from the LLM fails to be converted into the ladder diagram due to insufficient information, outputting a message prompting a user to input the insufficient information;
generating a second prompt including information additionally input by the user;
transmitting the second prompt to the LLM and receiving a second response statement; and
converting a second text code included in the second response statement into the ladder diagram.

19. The computer program product of claim 15, wherein the programmable logic controller includes a motion unit, and the fourth information includes a point parameter indicating movement coordinates of a control target in the motion unit.

20. The computer program product of claim 15, the operations further comprising:
prior to generating the prompt, performing an element analysis on the third information to decompose the third information into a plurality of elements;
transmitting a query including the plurality of elements to a database storing related information for the plurality of elements; and
receiving the related information from the database,
wherein the prompt is generated based on the received related information in addition to the first, second, and third information.
